(19) United States
(12) Patent Application Publication
(10) Pub. No.: US 2014/0234499 A1
(43) Pub. Date: Aug. 21, 2014

(54) SYSTEM AND METHOD FOR SANDWICH PREPARATION

(71) Applicants: Richard Shandelman, Lafayette Hill, PA (US); Michael Samschick, Villanova, PA (US)

(72) Inventors: Richard Shandelman, Lafayette Hill, PA (US); Michael Samschick, Villanova, PA (US)

(21) Appl. No.: 14/167,360

(22) Filed: Jan. 29, 2014

Related U.S. Application Data
(60) Provisional application No. 61/757,815, filed on Jan. 29, 2013.

(51) Int. Cl. A21C 15/00; B65D 65/02; A21D 8/02

(52) U.S. Cl. CPC A21C 15/007; A21D 8/02; B65D 65/02
USPC 426/283; 426/496; 99/450.7; 229/87.04

(57) ABSTRACT

A system and method of sandwich preparation are disclosed. The sandwich is formed by filling a bread roll having a lengthwise cavity, closed at a distal end and open at a proximal end by inserting food items through said proximal end. A device for baking a bread roll with a pre-formed cavity is also disclosed. Device for inserting food items and condiments into the cavity are also disclosed.

### CROSS REFERENCE TO RELATED APPLICATIONS

This utility application claims the benefit under 35 U.S.C. §119(e) of provisional application Ser. No. 61/757,815 filed on Jan. 29, 2013, entitled “System and Method for Sandwich Preparation.” The entire disclosure of this provisional application is included herein by reference.

### FIELD OF INVENTION

The present invention relates to bread making and sandwich preparation.

### BACKGROUND OF THE INVENTION

The process of sandwich-making is well known. A popular variety of sandwich is made on a single piece of bread sliced lengthwise to form what is commonly termed a hoagie or sub sandwich. The hoagie is often filled with sliced meats or cheeses and accompanied by various condiments. Such a sandwich has the drawback that condiments tend to fall out of the sides or bottom end of the sandwich while it is being eaten. As these types of sandwiches are often prepared for consumption at sporting events, picnics and other situations where one is not sitting at a table with utensils, the loss of condiments from the sandwich can result in a sloppy and unpleasant eating experience. Thus, a need exists for a hoagie type sandwich that does not have the disadvantage of losing condiments or other food items while it is being eaten.

### BRIEF SUMMARY OF THE INVENTION

In and embodiment, there is disclosed a process for baking a loaf of bread with a cavity. The process includes the steps of applying bread dough around a baking core; baking said bread dough; and removing said baking core.

In a further embodiment, there is disclosed a process of preparing a sandwich, comprising the steps of; preparing a bread roll with a lengthwise cavity having an opening at only one end of the roll; arranging filler items on an insertion device; inserting the insertion device into the lengthwise cavity; and removing the insertion device, leaving the filler items in the bread roll. In a further embodiment of this process, there is included the step of inserting condiments into the lengthwise cavity before inserting said insertion device.

In a further embodiment, there is disclosed, wrapper for a sandwich comprising a sack portion generally conforming to the shape of the sandwich and open at a proximal end for insertion of the sandwich; and a handle portion at said proximal end.

In a further embodiment, there is disclosed, an apparatus for filling a bread roll having a lengthwise cavity comprising: a filler arranging bed; a filler arranging bed cover; and a filler extruder, wherein said filler arranging bed and cover are filled with food items, inserted into the cavity and said extruder is actuated to allow removal of said bed and cover from the cavity, leaving said food items inside of the cavity.

In a further embodiment, there is disclosed, an apparatus for filling a bread roll having a lengthwise cavity, comprising a filler arranging bed; a filler arranging bed cover; a filler plunger that fits between said filler arranging bed and bed cover and a filler arranging bed and bed cover remover; said filler arranging bed and bed covers having proximal and distal ends, wherein said plunger is affixed to a non-moving holder at said proximal end of said filler arranging bed and bed cover and said filler arranging bed and cover remover moves the filler arranging bed and cover so that said plunger exits the bed and bed cover at said distal ends.

### BRIEF DESCRIPTION OF SEVERAL VIEWS OF THE DRAWINGS

The invention will be described in conjunction with the following drawings in which like reference numerals designate like elements and wherein:

FIG. 1 is a three-dimensional view of an exemplary sandwich filling device;

FIG. 2 is a close-up view of the device of FIG. 1 with sandwich filling items loaded into the device;

FIG. 3 is a view of FIG. 2, with the device closed;

FIG. 4 is a view of the device of FIGS. 1, 2 and 3, with a roll installed around the sandwich filling items;

FIG. 5 is a view of the device of FIGS. 1, 2, 3, and 4 with the device lowered to allow removal of the completed sandwich;

FIG. 6 is a view of a completed sandwich;

FIG. 7 is a three dimensional view of an exemplary baking rod for formation of a bread loaf with a lengthwise cavity;

FIG. 8 is a view of an exemplary baking pan with several baking rods for vertical baking of bread loaves;

FIG. 9 is a front and side view of an exemplary baking rod;

FIG. 10 is a three-dimensional view of a sandwich filling device;

FIG. 11 is a further view of the sandwich filling device of FIG. 10;

FIG. 12 is a three dimensional view of two sides of the sandwich filling device of FIG. 10;

FIG. 13 is a system drawing of an exemplary condiment filling device;

FIG. 14 is a three-dimensional view of an exemplary sandwich bag;

FIG. 15 is a three-dimensional view of an exemplary device for horizontal baking;

FIG. 16 is a view of the device of FIG. 15, with unbaked dough applied;

FIG. 17 is a view of exemplary loaves of bread;

FIG. 18 is a view of a device for filling sandwiches;

FIG. 19 is a further view of the device of FIG. 18; and

FIG. 20 is a further view of the device of FIGS. 18 and 19.

### DETAILED DESCRIPTION OF THE INVENTION

In an embodiment of the invention, there is a sandwich-making process that includes the steps of baking a loaf of bread with a lengthwise cavity, open at one end and closed and the opposite end of the loaf of bread. In the next step, which is optional, liquid condiments such as olive oil, mayonnaise, ketchup or mustard are injected into the bread cavity. In the next step, sandwich fillers are arranged on an insertion device and the device is inserted into the bread cavity. Next, the insertion device is removed, leaving the sandwich fillers inside the bread loaf, thus completing the sandwich. The sandwich can be served as is or wrapped for later consumption. In a further aspect of the invention, a cylindrical wrapping is described for protecting and transporting the completed sandwich.

### Bread-Making Process

An exemplary bread making process consists of three stages, the preparation of the dough, insertion of the baking rod and bread baking process.

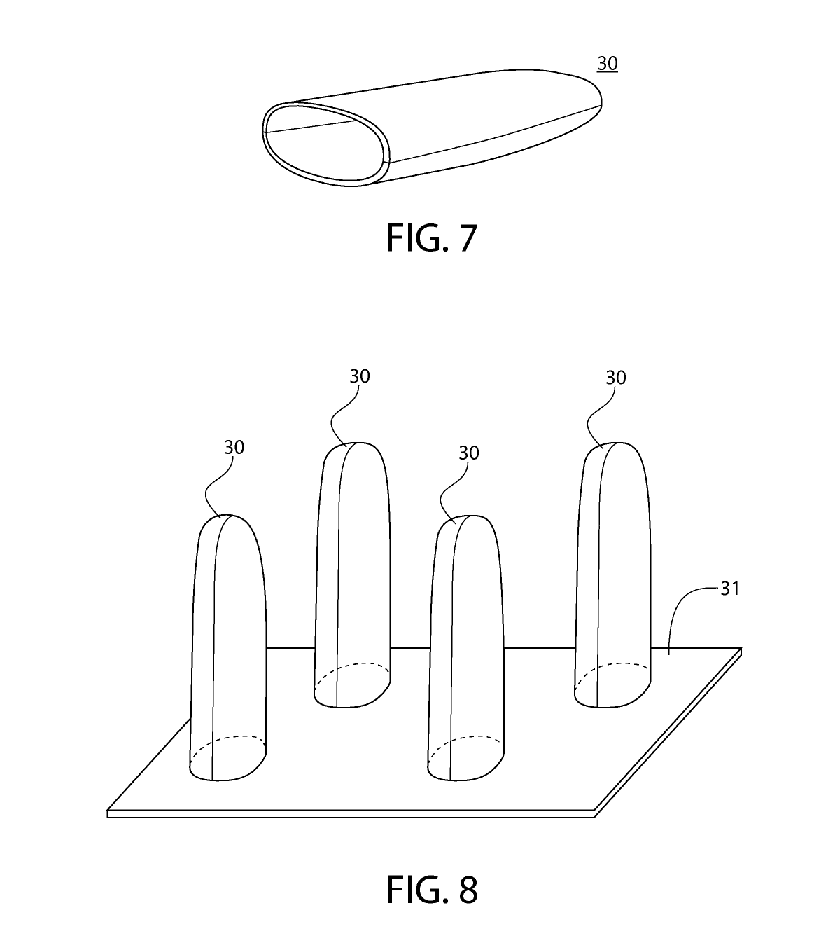

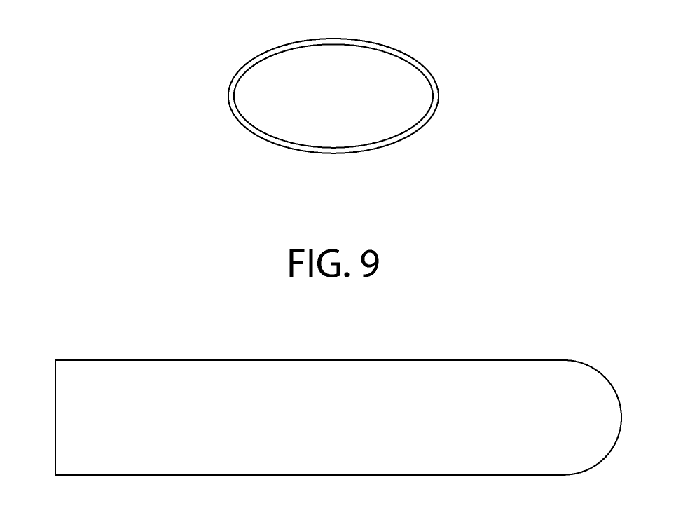

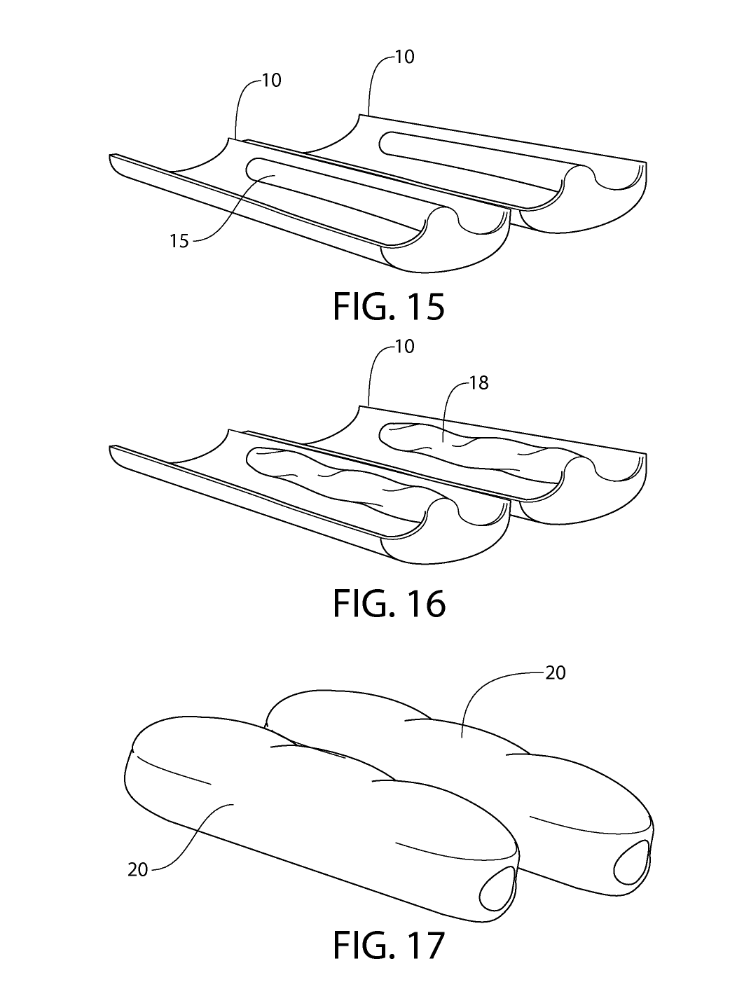

FIG. 15, shows two baking trays 10 with insert rods 15 for baking loaves of bread with a lengthwise cavity. FIG. 16 shows the tray of FIG. 15 with raw dough, 18 applied to the baking tray. FIG. 17 shows three exemplary loaves of bread 20 baked on trays and rods as described above. The baking rod, can made in any geometric shape; i.e cone, standard cylinder, oval, elliptical, square, etc. Exemplary rods are shown in FIGS. 7, and 9. The rod is made from FDA approved metal and/or nonstick material. The rod insert can be used to bake bread on its side on a conveyor type oven or in a stacked oven on pans. Alternatively, the rod can be positioned vertically as shown in FIG. 8. or can also be baked standing up. The dough, which can be any type of dough, i.e. Italian, sourdough, white, wheat, potato and the like, is prepared so the rod can either be inserted into the dough and/or the dough is wrapped around the rod. This process is done prior to baking. Once the rod and dough are joined, additional seasonings such as but not limited to sesame seeds, herbs, poppy seeds are placed on the surface of the bread. The dough on the rod is then placed in the oven. Once the bread is finished cooking, the rod is removed, cleaned, sterilized and ready to reuse. In an exemplary embodiment, the rod has an elliptical cross section as shown in FIG. 9. Typical dimensions of the rod of FIG. 9 are two inches wide by an inch and a half high and eight inches long. FIG. 8 shows an exemplary baking pan 31 for vertical placement with four baking rods 30

### Condiment Insertion

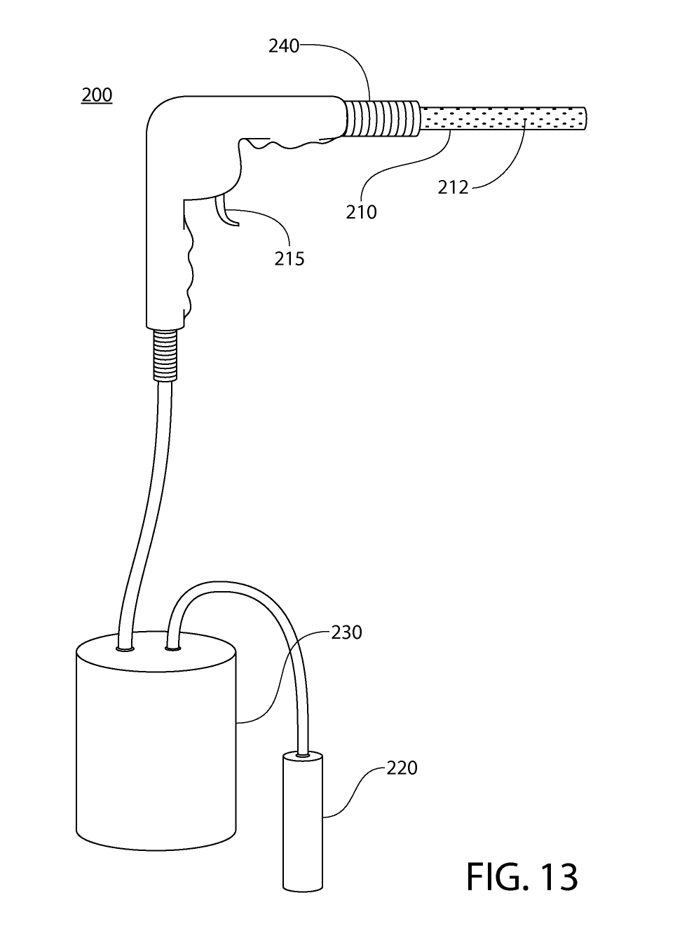

In an embodiment of the invention, there is a device for evenly dispersing dressings, condiments such as ketchup and mustard around the inside of the bread cavity. An exemplary such device is shown in FIG. 13 and descried below. The condiment inserter 200 has an injector nozzle 210, which is a long hollow tube, closed at the distal end with holes 212 on its surface. In an embodiment, the tube is also fluted with lengthwise groves (not shown.) Condiments are injected through the tube 210 by pulling a trigger 215 that opens a valve (not shown). The dispensing of the condiments from a condiment container 230 can be can be manually propelled by a manual pump or plunger or as shown in FIG. 13, delivery can be by compressed air 220. In either case, the condiments are evenly dispersed to form a coating on the inside of the bread a coat of each condiment ordered by the customer.

In an embodiment, a portion of the tube can be covered with an adjustable sleeve 240, to limit the area of the sandwich to be coated with the condiment or to accommodate different sized bread loaves.

### The Sandwich Making Process

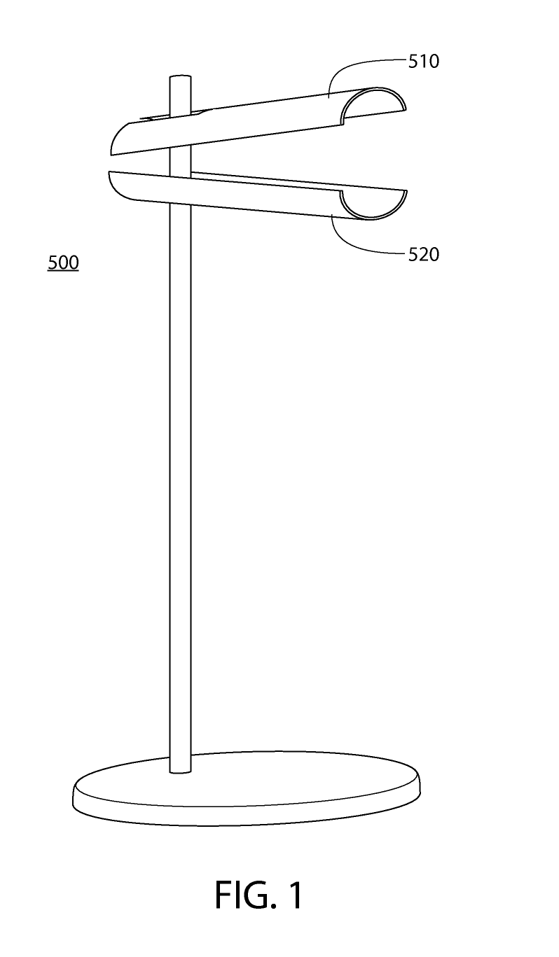

As shown in FIGS. 1-5, an exemplary food assembly device 500 is designed as a clam shell with top 510 and bottom 520 sections. These sections may or may not be the same size. When closed, the two sections form a complimentary shape of the cavity in the bread loaf, although this is not required and the filling device can have a shape other than the cavity in further embodiments. For instance, the filler sections may be smaller in cross section or length than the cavity. The overall volume of the shape may be equal, smaller or larger depending on the specifications and objective in filling the bread with specific ingredients.

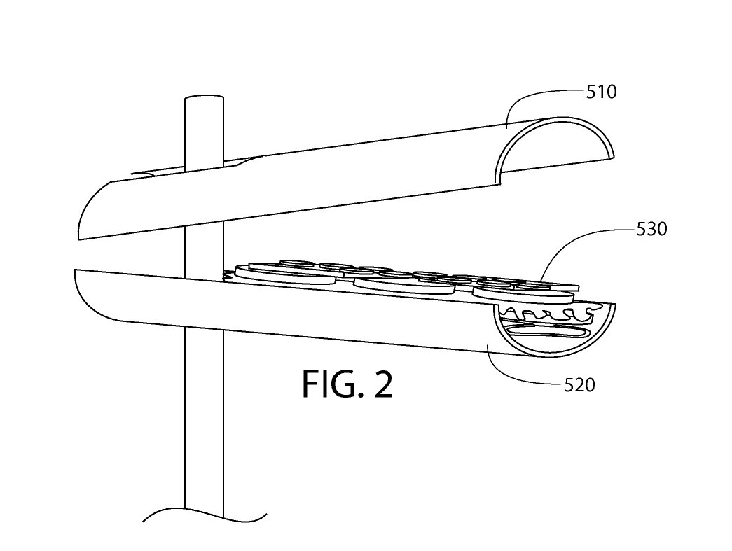

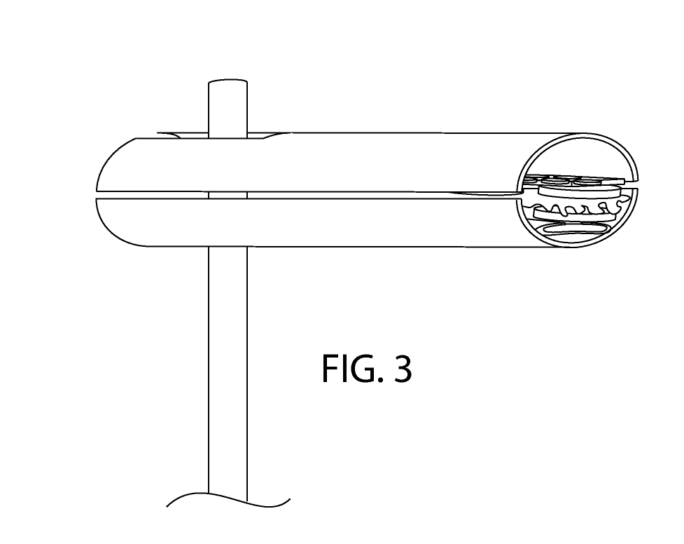

As shown in FIG. 2, when the clam shell 510, 520 is open, the food 530 is stacked on one side of the clam shell. Once all the ingredients are place in the bottom clam shell, the top clam shell is closed down on top of the bottom clam shell, as shown in FIG. 3.

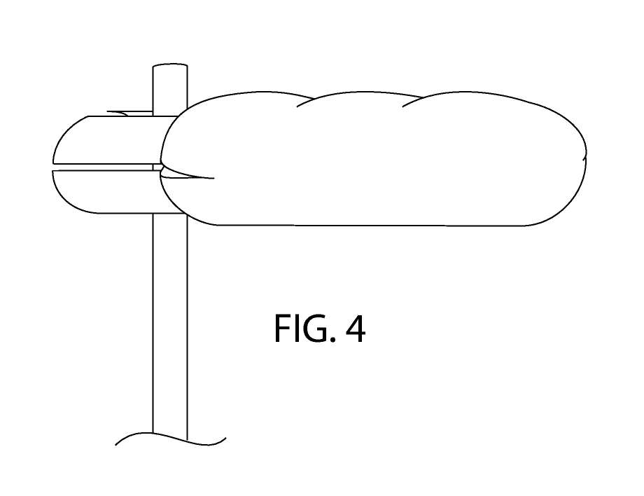

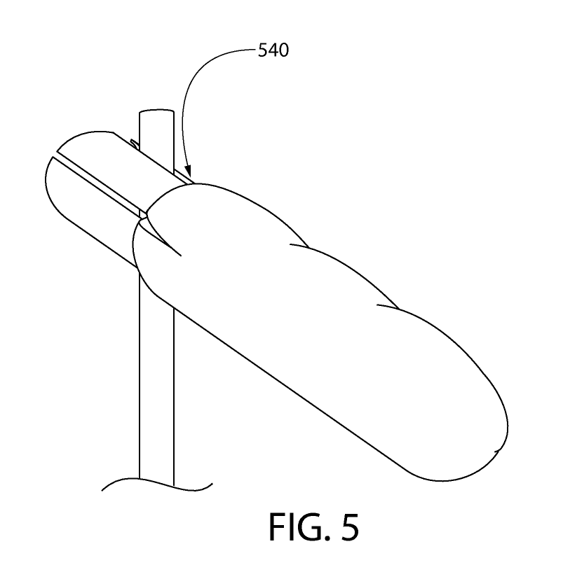

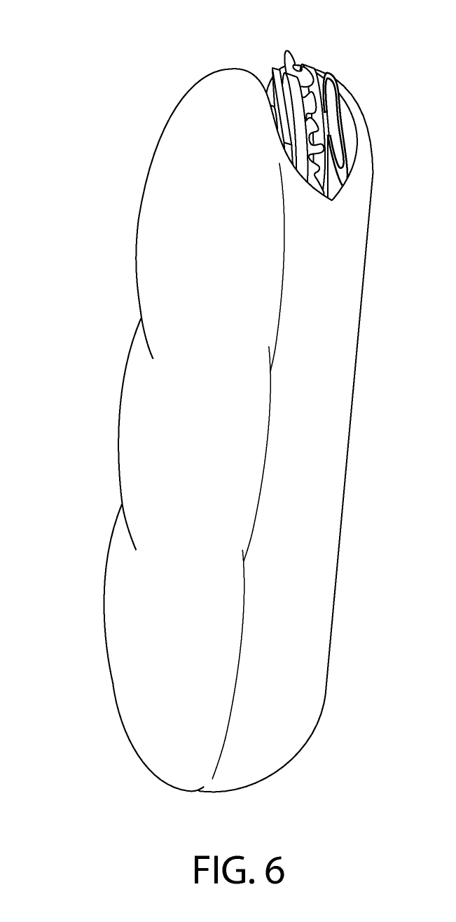

As shown in FIG. 4, the bread loaf is then slid over the clam shell. In the embodiment shown in FIG. 5, the device has a tilting capability, which allows the sandwich to be removed with the open end 540 at the top, thus using gravity to aid in keeping the sandwich filler elements in the sandwich. FIG. 6 shows an exemplary completed sandwich.

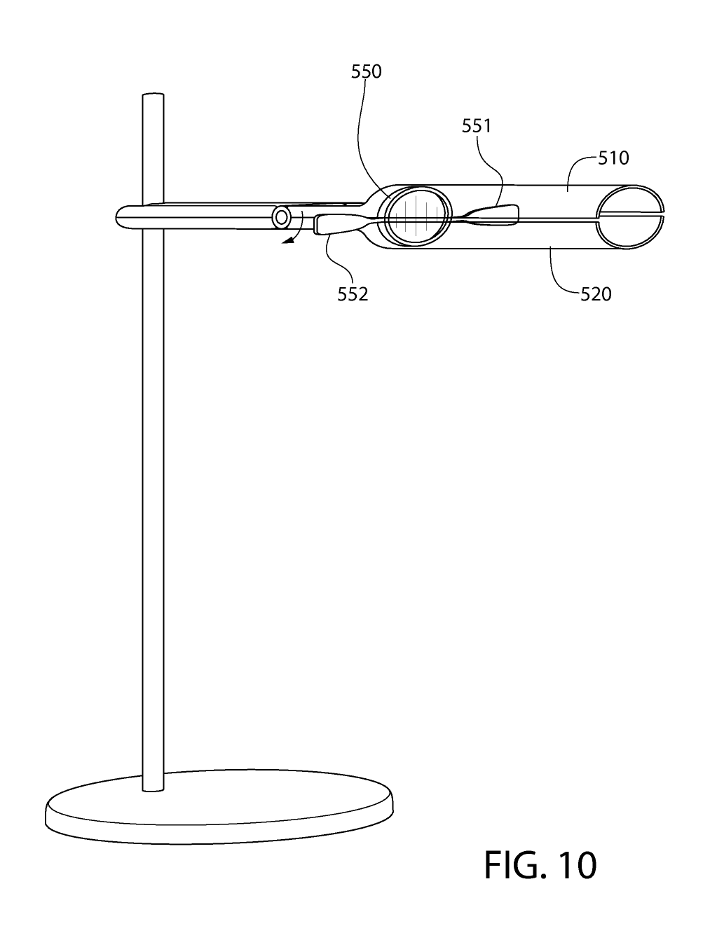

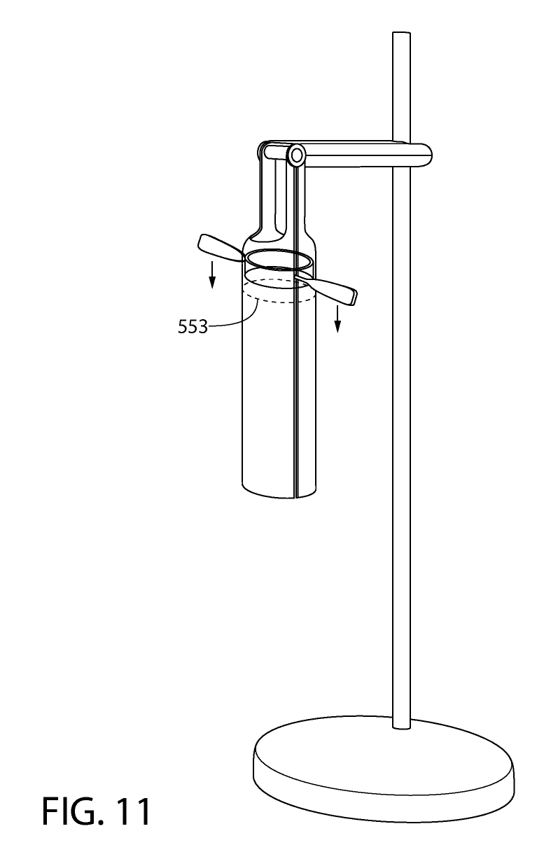

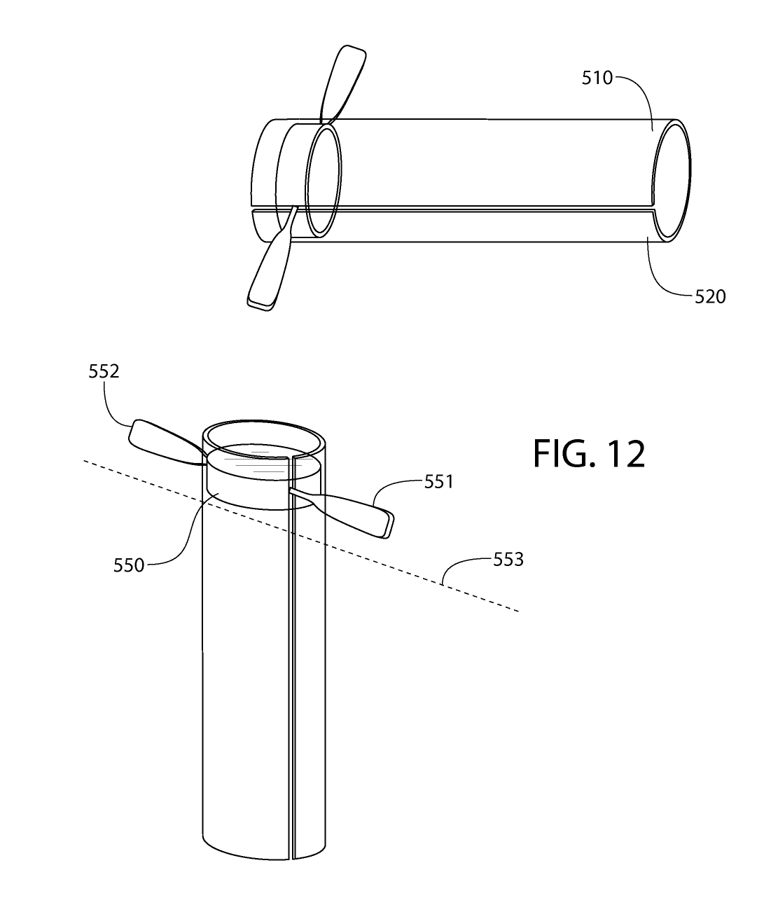

In an embodiment shown in FIGS. 10-12, the sandwich filling apparatus has a solid plunger 550 that is shaped similar to the internal shape of the closed clam shell 510, 520.

The plunger includes two attached dog-ears 551, 552. The operation of the filler is as follows: The loaded clam shells are inserted into the bread roll cavity up to the bread line 553. With one hand on the bread roll and the other on the dog ears 551, 552, the sandwich preparer slides the roll and dog ears in unison, downward towards the distal end of the clam shells 510, 520 and the sandwich filling materials are completely, quickly and easily transferred to the inside of the roll.

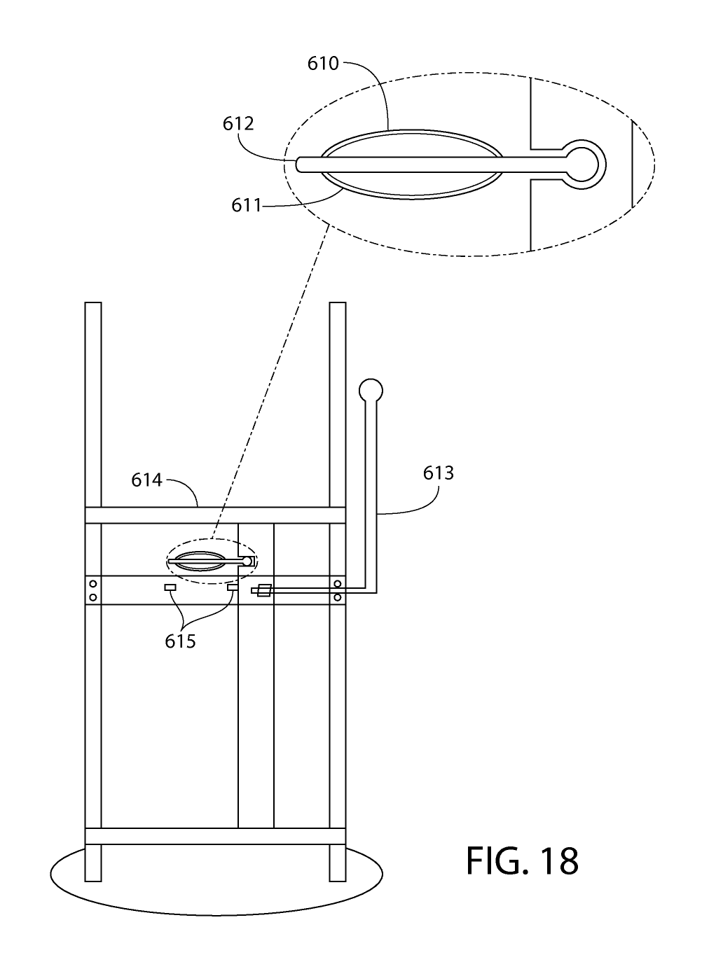

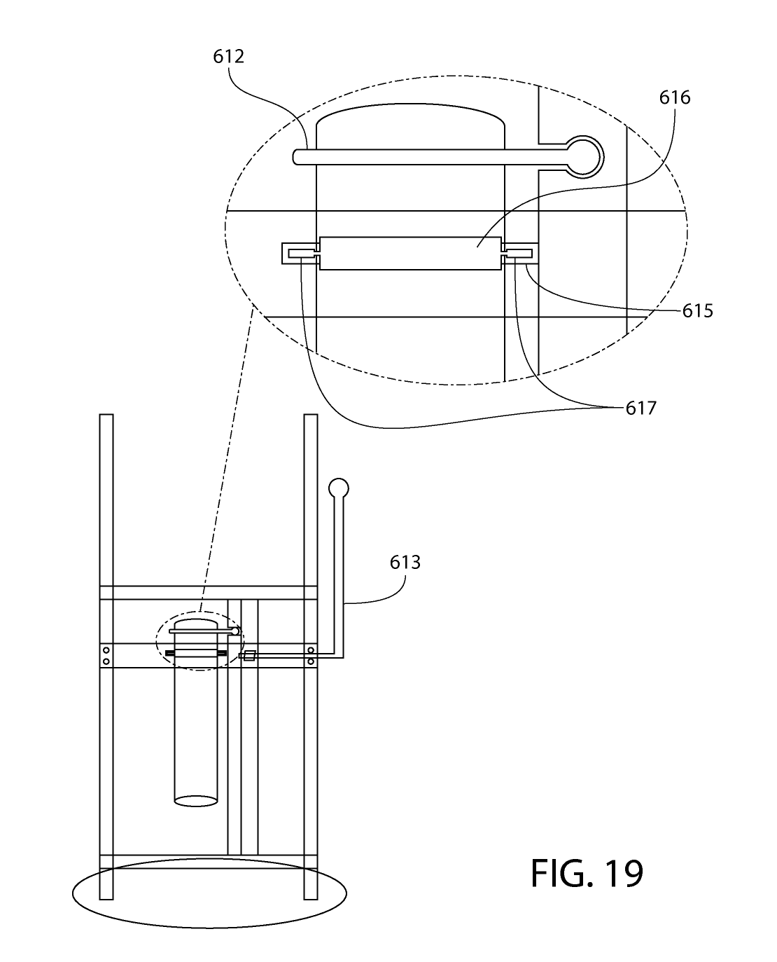

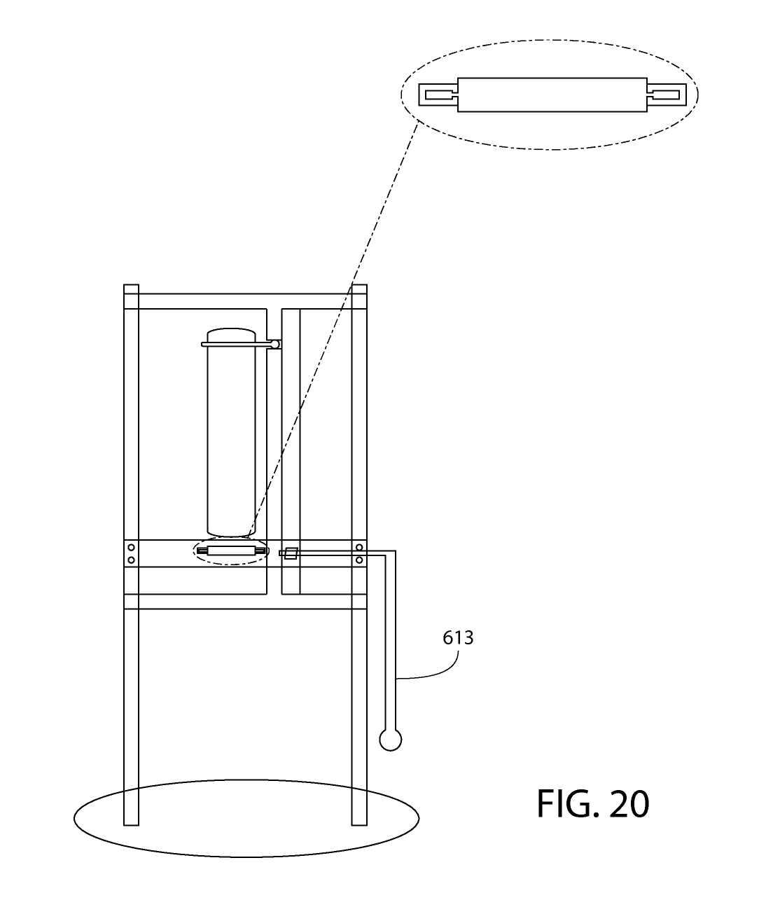

In a further embodiment, shown in FIGS. 18-20, there is a fixed plunger 616 that is placed the external end of the clam shells 610, 611. The clam shells are is mounted on a rack and pinion assembly 614 with accompanied handle 613 to operate the assembly. This plunger is set into place and roll (not shown) is fixed in place. The handle 613 is then rotated downward, raising the clam shell halves upward until they have been completely cleared of the bread. The plunger 616 remains fixed by virtue of two dog ears 617 that fit into slots 615 on the fixed portion of the assembly 614. The clam shells are mounted on an axle 612 that allows the clam shells to be filled in a horizontal position as shown in FIG. 18. A sandwich roll is applied over the clam shell halves while in the horizontal position and with the plunger 616 inserted at the proximal end of the clam shells and the open end of the roll. The sandwich and clam shells are then rotated downward to a vertical position, with the roll opening and the plunger at the top. The operator holds the roll in place and rotates the rack and pinion arm 613 to raise the clam shell halves up and out of the sandwich. The sandwich filling remains in the sandwich because the plunger remains in a fixed position relative to the sandwich. In a further embodiment, the actuation of the calm shell halves out of the sandwich is motorized.

### The Sandwich Bag

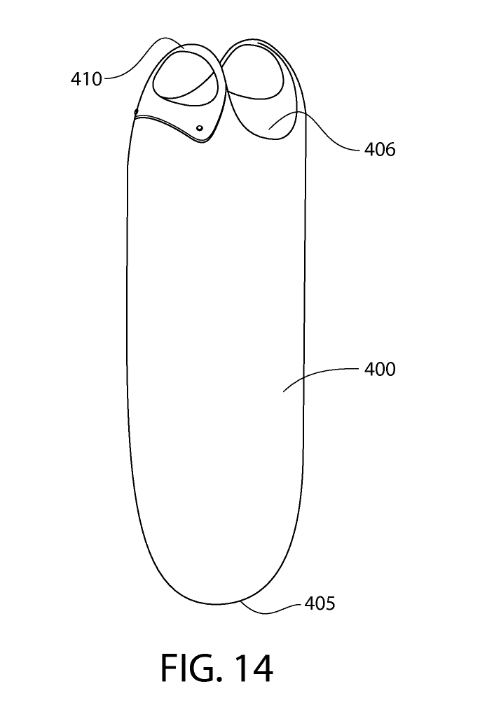

With reference to FIG. 14, there is shown a sandwich bag 400 with a shape that is similar to the hoagie roll with one closed 405 and one open end 406. The open end 406 has a handle 410 on it for easy portage and take out. The bag can be made from recycled paper or the like. The bag can have a dual purpose—1) for presenting to customer and easy carryout of the sandwich and 2) as a napkin. This bag can be made to have simple absorption properties of a napkin and also provide the tensile strength to handle the weight of the sandwich. Because the sandwich does not leak liquids from the closed end, the bag need not be waterproof and thus can be made from absorbing materials that allow it to double as a napkin.

This bread making and sandwich making processes has numerous applications, various sizes and configurations of rolls as well as various shapes and sizes of the roll cavity. Just to name a few rolls; rolls can be made for sandwiches, hoagies (grinders, subs, etc), hot dog rolls and many other types of applications.

Although for the purposes of this description, the bread has only one contiguous cavity, there can be more than one cavity in the bread to accommodate other bread and filing combination food designs.

While the invention has been described in detail and with reference to specific examples thereof, it will be apparent to one skilled in the art that various changes and modifications can be made therein without departing from the spirit and scope thereof.

What is claimed is:

1. A process for baking a loaf of bread with a cavity, comprising
applying bread dough around a baking core;
baking said bread dough; and
removing said baking core.

2. A process of preparing a sandwich, comprising;
preparing a bread roll with a lengthwise cavity having an opening at only one end of said roll;
arranging filler items on an insertion device;
inserting said insertion device into said lengthwise cavity; and
removing said insertion device, leaving said filler items in said bread roll.

3. The process of claim 2, further comprising
inserting condiments into said lengthwise cavity before inserting said insertion device.

4. A wrapper for a sandwich comprising
a sack portion generally conforming to the shape of the sandwich and open at a proximal end for insertion of the sandwich; and
a handle portion at said proximal end.

5. An apparatus for filling a bread roll having a lengthwise cavity comprising:
a filler arranging bed;
a filler arranging bed cover; and
a filler extruder,
wherein said filler arranging bed and cover are filled with food items, inserted into the cavity and said extruder is actuated to allow removal of said bed and cover from the cavity, leaving said food items inside of the cavity.

6. An apparatus for filling a bread roll having a lengthwise cavity, comprising
a filler arranging bed;
a filler arranging bed cover;
a filler plunger that fits between said filler arranging bed and bed cover and a filler arranging bed and bed cover remover;
said filler arranging bed and bed covers having proximal and distal ends wherein said plunger is affixed to a non-moving holder at said proximal end of said filler arranging bed and bed cover and said filler arranging bed and cover remover moves the filler arranging bed and cover so that said plunger exits the bed and bed cover at said distal ends.
